(19) United States
(12) Patent Application Publication
(10) Pub. No.: US 2024/0373138 A1
(43) Pub. Date: Nov. 7, 2024

(54) PROCESSING APPARATUS, PROCESSING METHOD, AND PROCESSING PROGRAM

(71) Applicant: FUJIFILM Corporation, Tokyo (JP)

(72) Inventors: Tomoharu SHIMADA, Saitama-shi (JP); Tetsuro ASHIDA, Saitama-shi (JP); Yuta ABE, Saitama-shi (JP); Morito NISEKI, Saitama-shi (JP)

(73) Assignee: FUJIFILM Corporation, Tokyo (JP)

(21) Appl. No.: 18/772,281

(22) Filed: Jul. 15, 2024

Related U.S. Application Data
(63) Continuation of application No. PCT/JP2023/007339, filed on Feb. 28, 2023.

(30) Foreign Application Priority Data
Feb. 28, 2022 (JP) 2022-030052

(51) Int. Cl. H04N 23/951; H04N 23/611; H04N 23/90

(52) U.S. Cl. CPC H04N 23/951; H04N 23/611; H04N 23/90

(57) ABSTRACT

A processing apparatus includes: a processor, and a memory. The processor is configured to: acquire first image data including a subject; determine a first composition of the subject in a first direction based on first information regarding a state of the subject; determine a second composition of the subject in a second direction different from the first direction based on second information different from the first information regarding the state of the subject; and generate second image data based on the first composition and the second composition.

### CROSS-REFERENCE TO RELATED APPLICATIONS

This is a continuation of International Application No. PCT/JP2023/007339 filed on Feb. 28, 2023, and claims priority from Japanese Patent Application No. 2022-030052 filed on Feb. 28, 2022, the entire content of which is incorporated herein by reference.

### BACKGROUND OF THE INVENTION

### 1. Field of the Invention

The present invention relates to a processing apparatus, a processing method, and a storage medium storing a processing program.

### 2. Description of the Related Art

JP2009-218807A discloses an imaging apparatus comprising: an imaging element that outputs a signal according to an optical image projected onto the imaging element by imaging; an image moving unit that moves the optical image on the imaging element; a face detection unit that detects a face of a person as a subject from a determination image based on an output signal of the imaging element, and detects a position and an orientation of the face on the determination image; and a composition control unit that controls the image moving unit based on the detected position and orientation of the face, and generates a composition adjustment image from the output signal of the imaging element after the control.

JP2007-124446A discloses a digital camera comprising: a display unit that displays image data; an imaging unit that includes a plurality of light-receiving elements that image a subject and generate image data; an extraction unit that extracts a feature part of the subject from the image data; a setting unit that sets a part of a predetermined angle-of-view range in a screen of an entire angle-of-view range imaged by the imaging unit displayed by the display unit according to an extraction result from the extraction unit; and an output unit that externally outputs only image data within the predetermined angle-of-view range set by the setting unit.

JP2008-252508A discloses an imaging apparatus comprising: an imaging unit that captures an image; an image processing unit that detects a specific portion of a target subject from a standard image captured by the imaging unit; a first control unit that controls the image captured by the imaging unit such that the specific portion of the target subject has a predetermined size; and a second control unit that controls the image captured by the imaging unit such that the specific portion of the target subject is at a predetermined position.

### SUMMARY OF THE INVENTION

According to an aspect of the present invention, there is provided a processing apparatus comprising: a processor; and a memory, in which the processor is configured to: acquire first image data including a subject; determine a first composition of the subject in a first direction based on first information regarding a state of the subject; determine a second composition of the subject in a second direction different from the first direction based on second information different from the first information regarding the state of the subject; and generate second image data based on the first composition and the second composition.

According to another aspect of the present invention, there is provided a processing method comprising: acquiring first image data including a subject; determining a first composition of the subject in a first direction based on first information regarding a state of the subject; determining a second composition of the subject in a second direction different from the first direction based on second information different from the first information regarding the state of the subject; and generating second image data based on the first composition and the second composition.

According to still another aspect of the present invention, there is provided a non-transitory computer-readable storage medium storing a processing program causing a processor to execute a process including: acquiring first image data including a subject; determining a first composition of the subject in a first direction based on first information regarding a state of the subject; determining a second composition of the subject in a second direction different from the first direction based on second information different from the first information regarding the state of the subject; and generating second image data based on the first composition and the second composition.

According to yet still another aspect of the present invention, there is provided a processing apparatus comprising: a processor; and a memory, in which the processor is configured to: acquire first image data including a subject; determine a first composition of the subject in a first direction based on first information regarding a state of the subject in the first image data; set a first ratio, which is a ratio of a width of second image data in the first direction to a width of the first image data in the first direction, based on the first information, the first composition, and a probability distribution; and generate the second image data based on the first ratio.

### BRIEF DESCRIPTION OF THE DRAWINGS

FIG. 1 is a diagram showing a schematic configuration of an image management system 100.

FIG. 2 is a schematic diagram for describing a direction of image data.

FIG. 3 is a flowchart for describing an image editing process by a processor 42.

FIG. 4 is a schematic diagram for describing an image editing process.

FIG. 5 is a schematic diagram for describing an image editing process.

FIG. 6 is a schematic diagram for describing an image editing process.

FIG. 7 is a schematic diagram for describing an image editing process.

FIG. 8 is a schematic diagram for describing an image editing process.

FIG. 9 is a schematic diagram for describing an image editing process.

FIG. 10 is a schematic diagram for describing an image editing process.

FIG. 11 is a schematic diagram for describing an image editing process.

FIG. 12 is a schematic diagram for describing an image editing process.

FIG. 13 is a schematic diagram for describing an image editing process.

FIG. 14 is a schematic diagram for describing an image editing process.

FIG. 15 is a schematic diagram for describing an image editing process.

FIG. 16 is a schematic diagram for describing an image editing process.

FIG. 17 is a diagram showing an example of a probability distribution.

FIG. 18 is a diagram showing an example of a probability distribution.

FIG. 19 is a flowchart for describing a modification example of the image editing process by the processor 42.

### DESCRIPTION OF THE PREFERRED EMBODIMENTS

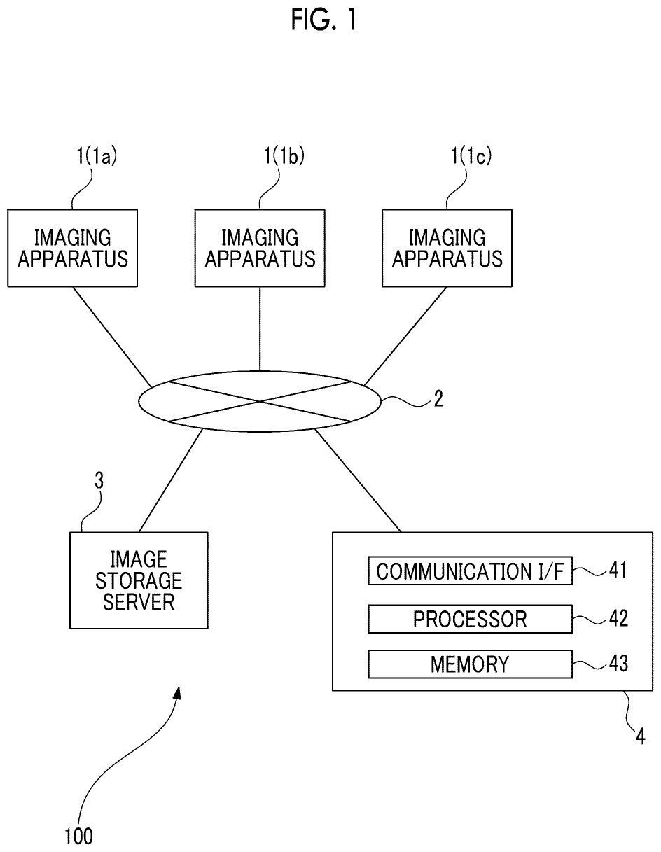

FIG. 1 is a diagram showing a schematic configuration of an image management system 100 including an image processing apparatus 4 that is an embodiment of a processing apparatus according to the present invention. The image management system 100 comprises one or a plurality of imaging apparatuses 1 (in the example of FIG. 1, there are three imaging apparatuses 1a, 1b, and 1c), a network 2 such as the Internet or a local area network (LAN), an image storage server 3, and an image processing apparatus 4. The imaging apparatus 1 is disposed in, for example, a theme park, an event venue, and the like. The three imaging apparatuses 1 are disposed at different positions and capture an image of a subject, such as a person or an animal, present at an installation location.

The imaging apparatus 1 includes an imaging element, an image processing circuit that processes a captured image signal obtained by capturing an image of a subject with the imaging element to generate image data, and a communication interface that can be connected to the network 2. The imaging apparatus 1 is composed of, for example, a digital camera, a smartphone, or the like. The image data generated by the imaging apparatus 1 will be also referred to as the image data captured by the imaging apparatus 1. It is preferable that a tag of the image data generated by the imaging apparatus 1 includes attribute information of the imaging apparatus 1 that has generated the image data, imaging conditions (a set zoom magnification, a set aspect ratio, and the like) of the imaging apparatus 1 that has generated the image data, and capabilities (a set range of the zoom magnification and the like) of the imaging apparatus 1 that has generated the image data, for a modification example to be described later.

The attribute information of the imaging apparatus 1 is information that defines the purpose of the imaging apparatus 1, that is, the type of image that is to be captured. For example, the imaging apparatus 1a is assigned with attribute information Z1 indicating that the imaging conditions and the installation location are determined such that the entire subject (the entire body) falls within an imaging range. On the other hand, the imaging apparatuses 1b and 1c are assigned with attribute information Z2 indicating that the imaging conditions and the installation location are determined such that a part of the subject (for example, a face) largely falls within the imaging range. In the image data captured by the imaging apparatus 1 to which the attribute information Z1 has been assigned, an area occupied by the subject with respect to the entire image data is smaller than an area occupied by the subject with respect to the image data captured by the imaging apparatus 1 to which the attribute information Z2 has been assigned. The imaging apparatus 1 transmits the generated image data to the image storage server 3 via the network 2.

The image storage server 3 comprises a processor, a communication interface that can be connected to the network 2, and a storage device such as a hard disk drive (HDD), a flash memory, a solid-state drive (SSD), or an electrically erasable and programmable read-only memory (EEPROM). The storage device may be a network storage device connected to the network 2. The processor of the image storage server 3 acquires image data (hereinafter referred to as first image data) transmitted from the imaging apparatus 1 and stores the acquired first image data in the storage device.

The image processing apparatus 4 is an apparatus for editing of the first image data stored in the storage device of the image storage server 3. The image processing apparatus 4 comprises a communication interface 41 for connecting to the network 2, a processor 42, and a memory 43. The memory 43 includes a random-access memory (RAM) used as a work memory and a non-volatile memory such as an HDD, a flash memory, an SSD, or an EEPROM. The non-volatile memory in the memory 43 is an example of a non-transitory storage medium readable by the processor 42. A processing program is stored in the non-volatile memory.

The processor 42 is a central processing unit (CPU) which is a general-purpose processor that executes software (program) to perform various functions, a programmable logic device (PLD), which is a processor capable of changing a circuit configuration after manufacture such as a field-programmable gate array (FPGA), a dedicated electrical circuit which is a processor having a circuit configuration exclusively designed to execute specific processing such as an application-specific integrated circuit (ASIC), or the like.

The processor 42 may be configured of one processor or a combination of two or more processors having the same type or different types (for example, a plurality of FPGAs, or a combination of CPU and FPGA). In a case in which the processor 42 is configured of a plurality of processors, each processor may not be in the same apparatus or may be in another place connected via the network 2. More specifically, the hardware structure of the processor 42 is an electrical circuit (circuitry) in which circuit elements, such as semiconductor elements, are combined.

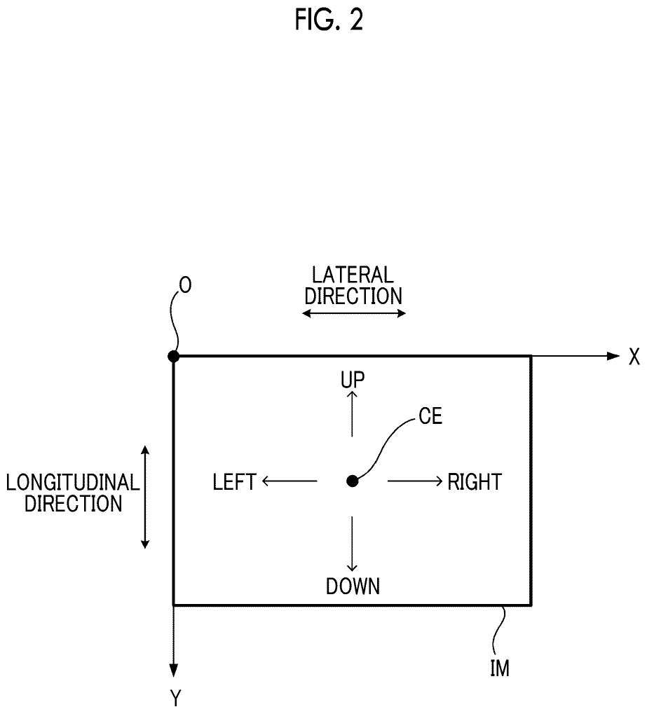

For all image data described in the present specification, top, bottom, left, and right are defined as shown in FIG. 2. FIG. 2 shows image data IM. The image data IM is two-dimensional image data having a rectangular outer shape. In FIG. 2, a two-dimensional orthogonal coordinate plane having an X-axis and a Y-axis orthogonal to each other as coordinate axes is assumed, and one vertex of the image data IM is disposed at an origin O of the coordinate plane. With the origin O as the base point, the image data IM is disposed in a positive direction of the X-axis and a positive direction of the Y-axis. When viewed from the center CE of the image data IM, a side heading in a negative direction of the X-axis is defined as a left side, a side heading in the positive direction of the X-axis is defined as a right side, a side heading in a negative direction of the Y-axis is defined as an upper side, and a side heading in the positive direction of the Y-axis is defined as a lower side.

The direction from the left side to the right side of the image data IM is referred to as a right direction, the direction opposite to the right direction is referred to as a left direction, and the right direction and the left direction are collectively referred to as a lateral direction. A direction from the upper side to the lower side of the image data IM is referred to as a downward direction, a direction opposite to the downward direction is referred to as an upward direction, and the downward direction and the upward direction are collectively referred to as a longitudinal direction. The lateral direction corresponds to a horizontal direction of the image data, and the longitudinal direction corresponds to a vertical direction of the image data. The lateral direction constitutes a first direction. The longitudinal direction constitutes a second direction.

Next, processes performed by the processor 42 will be described.

The processor 42 acquires first image data stored in the image storage server 3 from the image storage server 3 and performs an image editing process of trimming the first image data to generate second image data based on the acquired first image data. The processor 42 performs trimming such that a part (specifically, a face) of a subject, such as a person or an animal, included in the first image data is included in the second image data without being interrupted.

FIG. 3 is a flowchart for describing the image editing process by the processor 42. The processor 42 acquires first image data from the image storage server 3 (Step S1) and executes a subject detection process on the acquired first image data (Step S2).

The subject detection process is a process of detecting a specific subject, such as a person or an animal, from the first image data and further detecting a face region including a face of the subject. In this subject detection process, the orientation of the face of the subject is also detected in the first image data. That is, the processor 42 can distinguish and detect whether the orientation of the face detected in the first image data is the front orientation, the left orientation, or the right orientation.

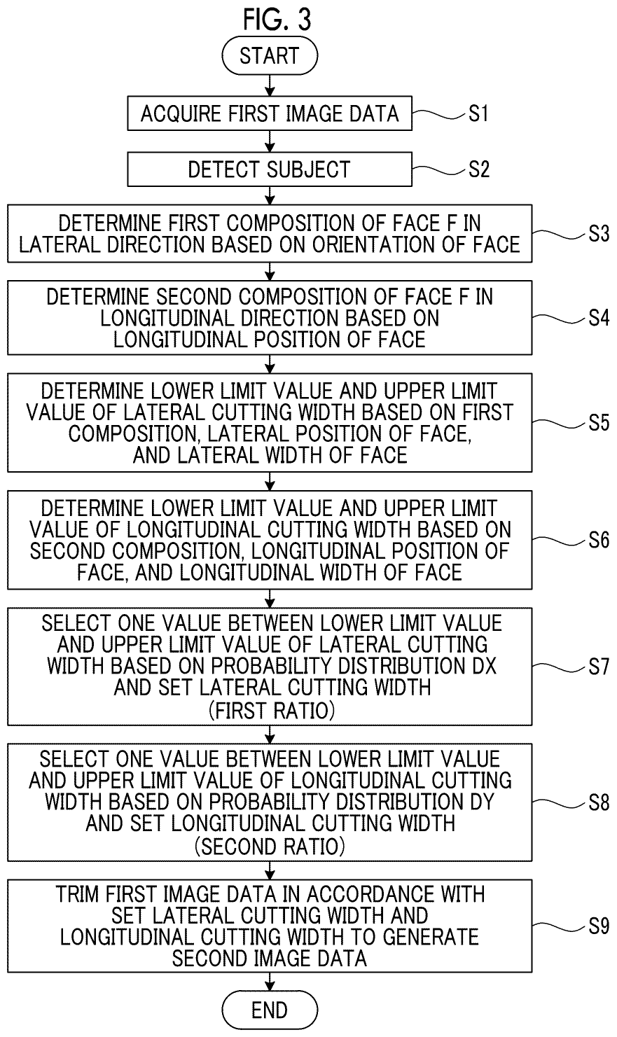

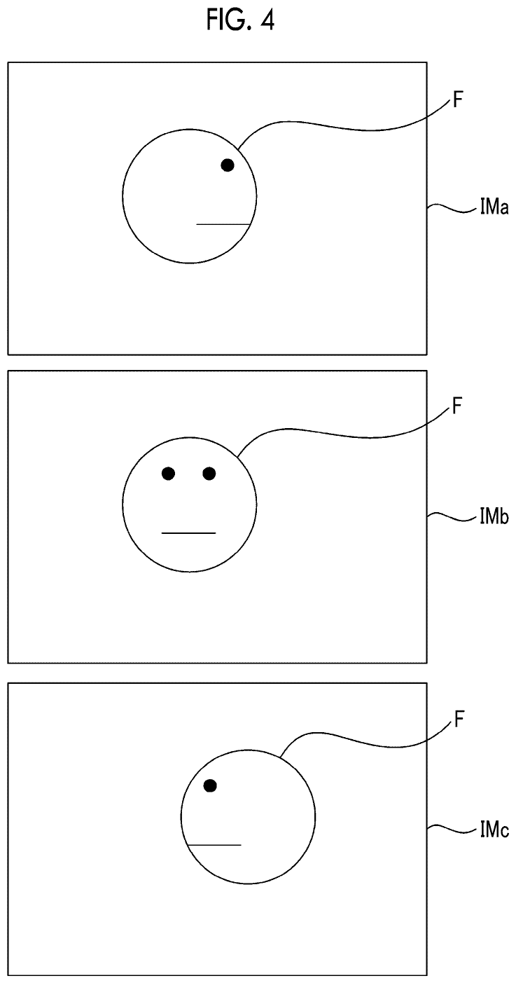

As shown in first image data IMa of FIG. 4, in a case in which a face F in the first image data IMa appears as a face facing the right direction, it is detected that the orientation of the face F is the right orientation. As shown in first image data IMb of FIG. 4, in a case in which the face F in the first image data IMb appears as a face seen from the front, it is detected that the orientation of the face F is the front orientation. As shown in first image data IMc of FIG. 4, in a case in which the face F in the first image data IMc appears as a face facing the left direction, it is detected that the orientation of the face F is the left orientation. In the first image data shown in FIG. 4, the face F in the front orientation faces the direction orthogonal to both the X-axis and the Y-axis, the face F in the left orientation faces the negative direction of the X-axis, and the face F in the right orientation faces the positive direction of the X-axis.

Face detection information included in the result of the subject detection process performed by the processor 42 is information for specifying “a position of the face, an orientation of the face, and a size of the face” in the first image data. For example, the processor 42 extracts a rectangular region including a face as a face region and expresses the position and size of the face based on a center position and a size (the number of pixels in both the vertical and horizontal directions) of the face region in the first image data. The position of the face includes a position in the lateral direction (hereinafter also referred to as a lateral position) and a position in the longitudinal direction (hereinafter also referred to as a longitudinal position). The size of the face includes a size in the lateral direction (hereinafter also referred to as a lateral width) and a size in the longitudinal direction (hereinafter also referred to as a longitudinal width). The processor 42 may extract a rectangular region including the entire body of the subject as a subject region, and acquire the position and the size of the subject based on the center position and the size of the subject region in the first image data.

Through the process in Step S2, the processor 42 acquires information regarding the lateral position, the orientation, the lateral width (the number of pixels), the longitudinal position, and the longitudinal width (the number of pixels) of the face (preferably, the entire body) included in the first image data. Information regarding the lateral position of the face, information regarding the orientation of the face, and information regarding the lateral width of the face constitute first information regarding a state of the subject included in the first image data, and information regarding the longitudinal position of the face and information regarding the longitudinal width of the face constitute second information different from the first information regarding the state of the subject.

Then, the processor 42 determines a first composition of the face F in the lateral direction of the second image data set as a generation target based on the lateral position, the orientation, and the lateral width (first information) of the face F detected from the first image data (Step S3). Further, the processor 42 determines a second composition of the face F in the longitudinal direction of the second image data set as the generation target based on the longitudinal position and the longitudinal width (second information) of the face F detected from the first image data (Step S4).

Specific examples of a method of determining the first composition and a method of determining the second composition will be described below. Specifically, the distance on the image data described in the present embodiment is defined by the number of pixels.

In the following, a right end of a trimming range in the lateral direction in the first image data is defined as a right cutting line R1, and a left end thereof is defined as a left cutting line L1. In addition, an upper end of a trimming range in the longitudinal direction in the first image data is defined as an upper cutting line U1, and a lower end thereof is defined as a lower cutting line D1.

### (Method of Determining First Composition)

For the composition in the lateral direction, the processor 42 determines a composition in which the region on the direction side in which the face F faces is larger than the region on the side opposite to the side in which the face F faces with the face F as a boundary, depending on the orientation of the face F. In a case in which the orientation of the face F is the front, the processor 42 determines a composition in which the regions are even on the right side and the left side with the face F as a boundary.

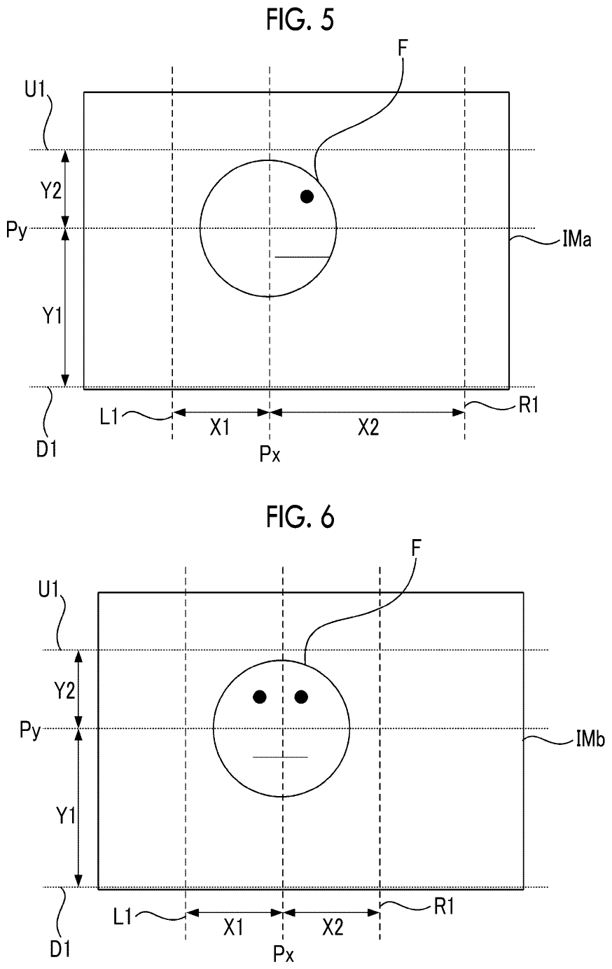

In a case in which the first composition is determined based on the first image data IMa shown in FIG. 4, as shown in FIG. 5, the processor 42 determines the composition of the face Fin the lateral direction by setting a ratio of a distance X2 between a right cutting line R1 on the right side facing the face F and a lateral position Px of the face F to a distance X1 between a left cutting line L1 on the left side opposite to the side facing the face F and the lateral position Px of the face F to a value in which the distance X2 is greater than the distance X1. As an example, X1:X2=1:2.

In a case in which the first composition is determined based on the first image data IMb shown in FIG. 4, as shown in FIG. 6, the processor 42 determines the composition of the face Fin the lateral direction by setting the ratio of a distance X2 between a right cutting line R1 and a lateral position Px of the face F to a distance X1 between a left cutting line L1 and the lateral position Px of the face F to a value in which the distance X1 and the distance X2 are the same.

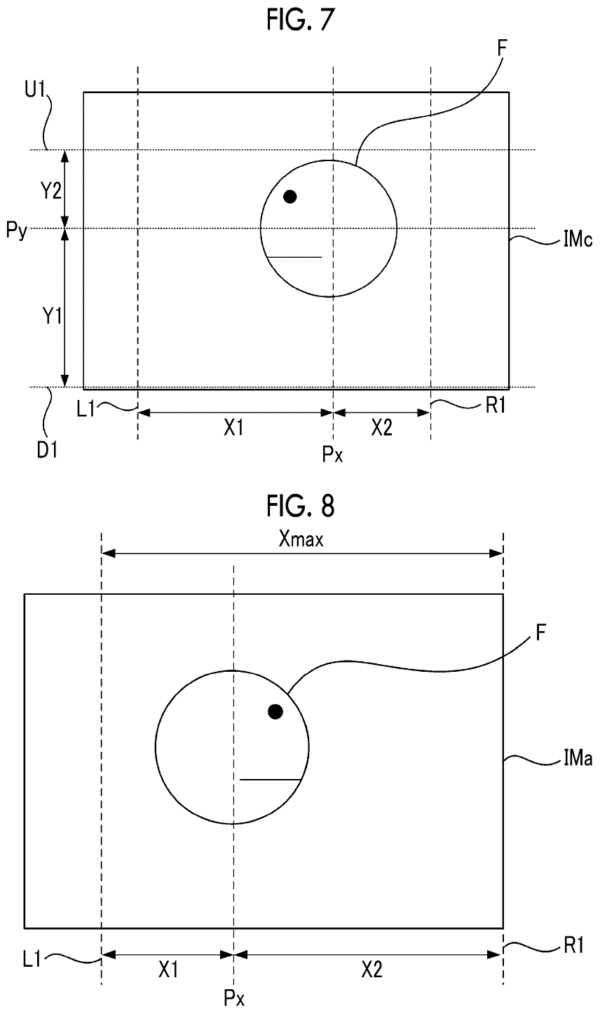

In a case in which the first composition is determined based on the first image data IMc shown in FIG. 4, as shown in FIG. 7, the processor 42 determines the composition of the face Fin the lateral direction by setting a ratio of a distance X1 between a left cutting line L1 on the left side facing the face F and a lateral position Px of the face F to a distance X2 between a right cutting line R1 on the right side opposite to the side facing the face F and the lateral position Px of the face F to a value in which the distance X1 is greater than the distance X2. As an example, X1:X2=2:1.

### (Method of Determining Second Composition)

For the composition in the longitudinal direction, the processor 42 determines a composition in which the upper region is smaller than the lower region with the face F as a boundary, regardless of the orientation of the face F.

In the case of any of the first image data IMa, the first image data IMb, and the first image data IMc shown in FIG. 4, the processor 42 determines the composition of the face F in the longitudinal direction by setting a ratio of a distance Y1 between a longitudinal position Py of the face F and a lower cutting line D1 to a distance Y2 between the longitudinal position Py of the face F and a upper cutting line U1 to a value in which the distance Y1 is greater than the distance Y2. As an example, Y1:Y2=2:1.

After the processes in Step S3 and Step S4, the processor 42 determines an upper limit value and a lower limit value of a distance between the right cutting line R1 and the left cutting line L1 (hereinafter referred to as a lateral cutting width) based on the determined first composition, the lateral position of the face F, and the lateral width of the face F (Step S5). The lateral cutting width is synonymous with the lateral width of the second image data as a generation target.

In addition, after the processes in Step S3 and Step S4, the processor 42 determines an upper limit value and a lower limit value of a distance between the upper cutting line U1 and the lower cutting line D1 (hereinafter referred to as a longitudinal cutting width) based on the determined second composition, the longitudinal position of the face F, and the longitudinal width of the face F (Step S6). The longitudinal cutting width is synonymous with the longitudinal width of the second image data as a generation target. The lateral cutting width and the longitudinal cutting width are also collectively referred to as a cutting width.

Hereinafter, specific examples of a method of determining the upper limit value and the lower limit value of the cutting width will be described.

### (Determination of Upper Limit Value of Lateral Cutting Width)

In the example of the first image data IMa including the face F facing the right, the processor 42 determines the lower limit value as follows in a first case in which the distance from the lateral position Px to the left end of the first image data IMa is (X1/X2) times or more the distance from the lateral position Px to the right end of the first image data IMa and a second case in which the distance from the lateral position Px to the left end of the first image data IMa is less than (X1/X2) times the distance from the lateral position Px to the right end of the first image data IMa.

In the first case, as shown in FIG. 8, the processor 42 determines the upper limit value of the lateral cutting width as a distance Xmax between the right cutting line R1 and the left cutting line L1 in a case in which the position of the left cutting line L1 is determined such that X1:X2=1:2 is maintained in a state in which the right cutting line R1 is aligned with the right end of the first image data IMa.

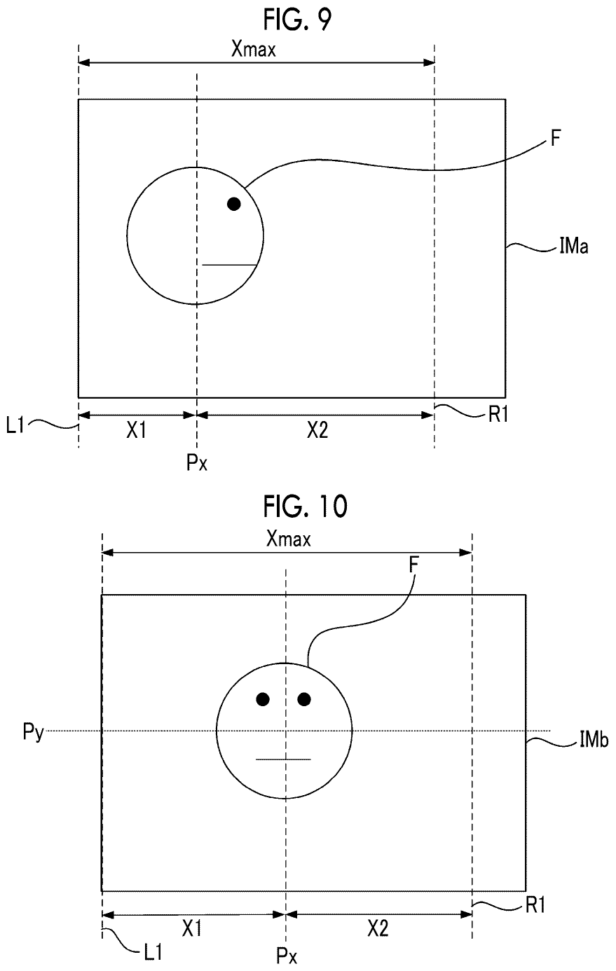

In the second case, as shown in FIG. 9, the processor 42 determines the upper limit value of the lateral cutting width as a distance Xmax between the right cutting line R1 and the left cutting line L1 in a case in which the position of the right cutting line R1 is determined such that X1:X2=1:2 is maintained in a state in which the left cutting line L1 is aligned with the left end of the first image data IMa.

Since the method of determining the upper limit value of the lateral cutting width in the first image data IMc including the face F facing the left is the same as the method of determining the upper limit value of the lateral cutting width in the first image data IMa, the description thereof will be omitted.

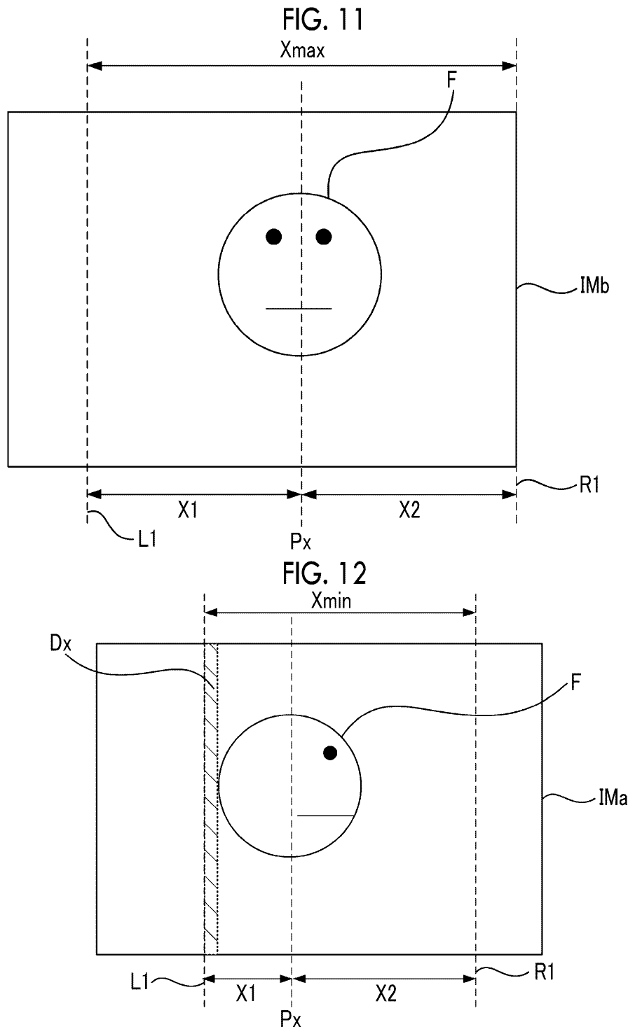

In the example of the first image data IMb including the face F facing the front, the processor 42 changes a method of determining the upper limit value between a case in which the distance between the lateral position Px and the right end of the first image data IMb is greater than the distance between the lateral position Px and the left end of the first image data IMb, as shown in FIG. 10 and a case in which the distance between the lateral position Px and the right end of the first image data IMb is smaller than the distance between the lateral position Px and the left end of the first image data IMb, as shown in FIG. 11.

In the example shown in FIG. 10, the processor 42 determines the upper limit value of the lateral cutting width as the distance Xmax between the right cutting line R1 and the left cutting line L1 in a case in which the position of the right cutting line R1 is determined such that X1:X2=1:1 is maintained in a state in which the left cutting line L1 is aligned with the left end of the first image data IMb.

In the example shown in FIG. 11, the processor 42 determines the upper limit value of the lateral cutting width as the distance Xmax between the right cutting line R1 and the left cutting line L1 in a case in which the position of the left cutting line L1 is determined such that X1:X2=1:1 is maintained in a state in which the right cutting line R1 is aligned with the right end of the first image data IMb.

In a case in which a ratio of the width of the imaging region included in the second image data in the lateral direction to the width of the imaging region included in the first image data in the lateral direction (for example, a value obtained by dividing the lateral width of the second image data by the lateral width of the first image data) is defined as a first ratio, the process of determining the upper limit value of the lateral cutting width can be considered to be equivalent to a process of determining the upper limit value of the first ratio.

### (Determination of Lower Limit Value of Lateral Cutting Width)

In the example of the first image data IMa including the face F facing the right, as shown in FIG. 12, the processor 42 sets a margin region Dx from the left end of the face F (end on the side opposite to the facing direction) to the left side. Then, the processor 42 determines the lower limit value of the lateral cutting width as a distance Xmin between the right cutting line R1 and the left cutting line L1 in a case in which the position of the right cutting line R1 is determined such that a relationship of X1:X2=1:2 is maintained in a state in which the left cutting line L1 is aligned with the left end of the margin region Dx. A margin width, which is a width (the number of pixels) of the margin region Dx in the lateral direction, may be a value determined in advance or may be a value selected by the user.

A method of determining the lower limit value of the lateral cutting width in the first image data IMc including the face F facing the left is as follows. The processor 42 sets a margin region Dx from the right end of the face F (end on the side opposite to the facing direction) to the right side. Then, the processor 42 determines, as the lower limit value of the lateral cutting width, a distance between the right cutting line R1 and the left cutting line L1 in a case in which the position of the left cutting line L1 is determined such that a relationship of X1:X2=2:1 is maintained in a state in which the right cutting line R1 is aligned with the right end of the margin region Dx.

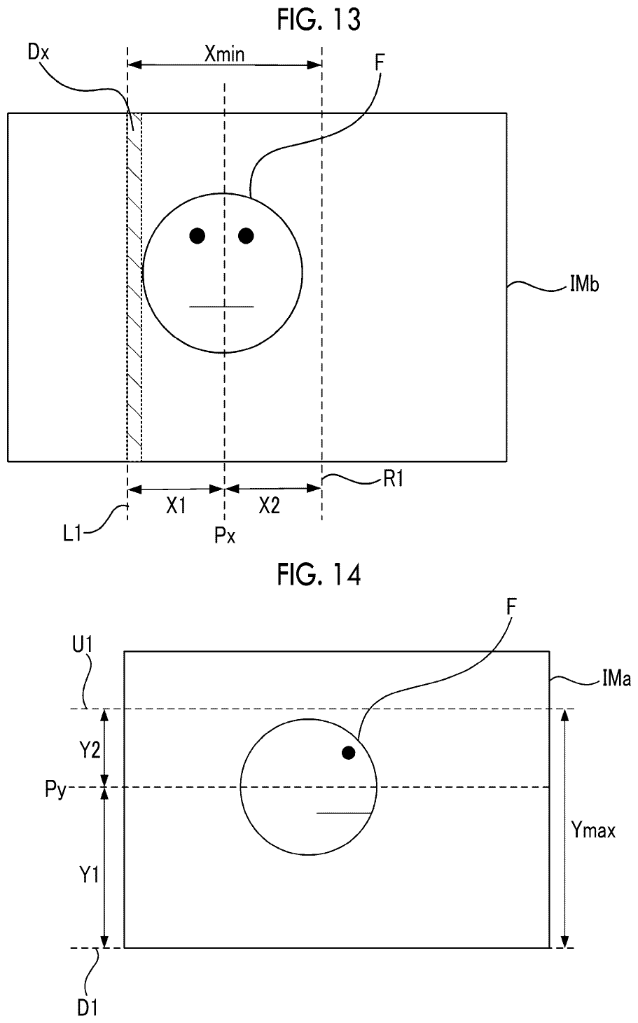

In the example of the first image data IMb including the face F facing the front, as shown in FIG. 13, the processor 42 sets the margin region Dx from the left end of the face F to the left side. Then, the processor 42 determines the lower limit value of the lateral cutting width as the distance Xmin between the right cutting line R1 and the left cutting line L1 in a case in which the position of the right cutting line R1 is determined such that a relationship of X1:X2=1:1 is maintained in a state in which the left cutting line L1 is aligned with the left end of the margin region Dx. In addition, the processor 42 may set the margin region Dx from the right end of the face F to the right side.

In the present specification, the process of determining the lower limit value of the lateral cutting width can be considered as equivalent to the process of determining the lower limit value of the first ratio described above.

### (Determination of Upper Limit Value of Longitudinal Cutting Width)

In the case of any of the first image data IMa, the first image data IMb, and the first image data IMc shown in FIG. 4, the processor 42 determines the lower limit value as follows in a first case in which the distance from the longitudinal position Py to the upper end of the first image data is (Y2/Y1) times or more the distance from the longitudinal position Py to the lower end of the first image data and a second case in which the distance from the longitudinal position Py to the upper end of the first image data IMa is less than (Y2/Y1) times the distance from the longitudinal position Py to the lower end of the first image data IMa.

In the first case, as shown in FIG. 14, the processor 42 determines the upper limit value of the longitudinal cutting width as a distance Ymax between the upper cutting line U1 and the lower cutting line D1 in a case in which the position of the upper cutting line U1 is determined such that Y1:Y2=2:1 is maintained in a state in which the lower cutting line D1 is aligned with the lower end of the first image data IMa.

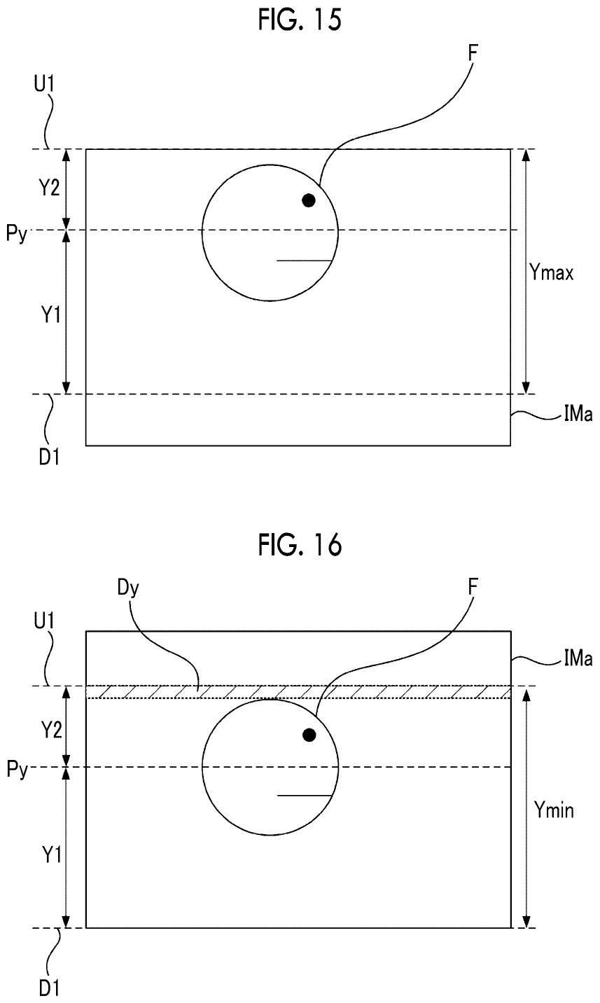

In the second case, as shown in FIG. 15, the processor 42 determines the upper limit value of the longitudinal cutting width as a distance Ymax between the upper cutting line U1 and the lower cutting line D1 in a case in which the position of the lower cutting line D1 is determined such that Y1:Y2=2:1 is maintained in a state in which the upper cutting line U1 is aligned with the upper end of the first image data IMa.

In a case in which a ratio of the width of the imaging region included in the second image data in the longitudinal direction to the width of the imaging region included in the first image data in the longitudinal direction (for example, a value obtained by dividing the longitudinal width of the second image data by the longitudinal width of the first image data) is defined as a second ratio, the process of determining the upper limit value of the longitudinal cutting width can be considered to be equivalent to a process of determining the upper limit value of the second ratio.

### (Determination of Lower Limit Value of Longitudinal Cutting Width)

In the case of any of the first image data IMa, the first image data IMb, and the first image data IMc shown in FIG. 4, the processor 42 sets a margin region Dy upward from the position of the upper end of the face F as shown in FIG. 16. Then, the processor 42 determines the lower limit value of the longitudinal cutting width as a distance Ymin between the upper cutting line U1 and the lower cutting line D1 in a case in which the position of the lower cutting line D1 is determined such that a relationship of Y1:Y2=2:1 is maintained in a state in which the upper cutting line U1 is aligned with the upper end of the margin region Dy. A margin width, which is a width (the number of pixels) of the margin region Dy in the longitudinal direction, may be a value determined in advance or may be a value selected by the user.

In the present specification, the process of determining the lower limit value of the longitudinal cutting width can be considered as equivalent to the process of determining the lower limit value of the second ratio described above.

The processor 42 sets the lateral cutting width based on the upper limit value and the lower limit value of the lateral cutting width determined as described above (in other words, the upper limit value and the lower limit value of the first ratio) and a probability distribution DX in which the lateral cutting width (in other words, the first ratio) is used as a probability variable (Step S7).

In addition, the processor 42 sets the longitudinal cutting width based on the upper limit value and the lower limit value of the longitudinal cutting width determined as described above (in other words, the upper limit value and the lower limit value of the second ratio) and a probability distribution DY in which the longitudinal cutting width (in other words, the second ratio) is used as a probability variable (Step S8). The memory 43 stores, for example, the probability distribution DX and the probability distribution DY in advance in the form of functions.

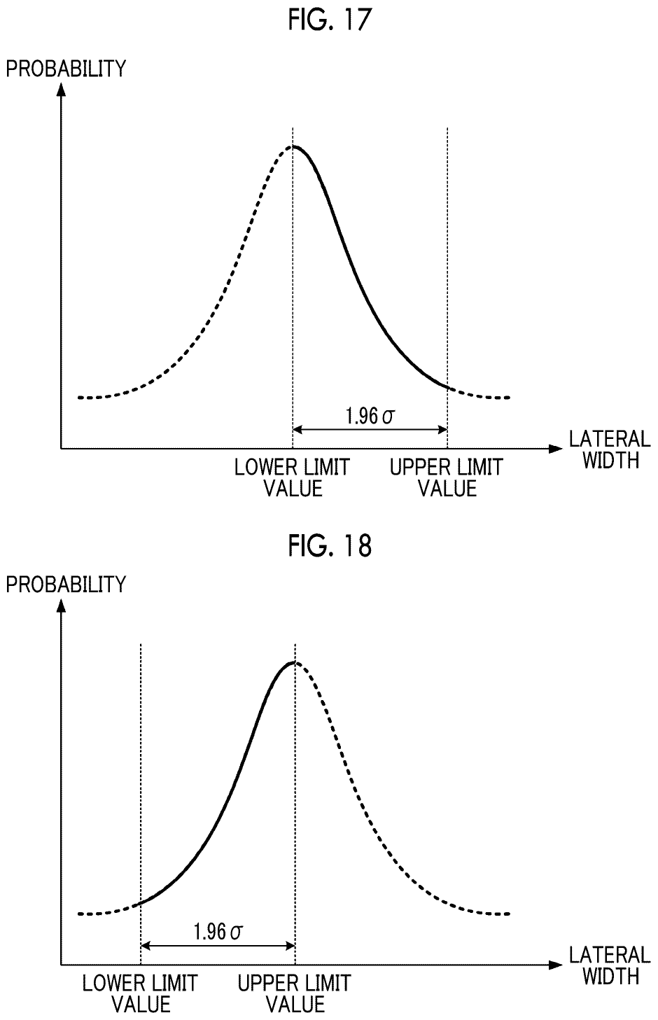

FIG. 17 is a diagram showing an example of a probability distribution DX of the lateral cutting width. The lateral axis of FIG. 17 indicates the lateral cutting width, and the longitudinal axis indicates the probability of selecting the lateral cutting width. The probability distribution DX stored in the memory 43 is a portion indicated by a thick solid line in FIG. 17. The probability distribution DX is a normal distribution indicated by a broken line in FIG. 17, and is a truncated normal distribution obtained by extracting only a range between an upper limit value and a lower limit value from a normal distribution in which a standard deviation σ is determined such that a probability variable having a maximum probability is the lower limit value of the lateral cutting width and a value obtained by adding 1.96σ (σ is a standard deviation) to the lower limit value is the upper limit value of the lateral cutting width. In Step S7, the processor 42 acquires the probability distribution DX illustrated in FIG. 17 and selects one value between the determined upper limit value and lower limit value of the lateral cutting width in accordance with the probability of the acquired probability distribution DX. The probability distribution DX shown in FIG. 17 is such that there is a high probability that a value close to the lower limit value will be selected by the processor 42.

Note that, in Step S8, the longitudinal cutting width is set based on the probability distribution DY that is a truncated normal distribution obtained by extracting only a range between an upper limit value and a lower limit value from a normal distribution in which a standard deviation σ is determined such that a probability variable having a maximum probability is the lower limit value of the longitudinal cutting width and a value obtained by adding 1.96σ (σ is a standard deviation) to the lower limit value is the upper limit value of the longitudinal cutting width, in the same manner as the probability distribution DX.

The probability distribution DX and the probability distribution DY are not limited to those shown in FIG. 17, and various others can be employed. For example, as indicated by the thick solid line in FIG. 18, the probability distribution DX and the probability distribution DY may be such that there is a high probability that a value close to the upper limit value will be selected. Alternatively, the probability distribution DX and the probability distribution DY may be distributions in which the probability is constant for all the values between the upper limit value and the lower limit value.

The processor 42 trims the first image data in accordance with the lateral cutting width and the longitudinal cutting width set as described above to generate second image data (Step S9). Hereinafter, a specific example of the trimming method will be described.

### (Trimming Method of First Image Data)

Here, a specific example of the case of the first image data IMa will be described. Further, the lateral cutting width set in Step S7 is referred to as Xset, and the longitudinal cutting width set in Step S8 is referred to as Yset. The processor 42 confirms a position separated by a distance obtained by performing a calculation of Xset×(X2/(X1+X2)) from the lateral position Px on the right side as the right cutting line R1. The processor 42 confirms a position separated by a distance obtained by performing a calculation of Xset×(X1/(X1+X2)) from the lateral position Px on the left side as the left cutting line L1.

The processor 42 confirms a position separated by a distance obtained by performing a calculation of Yset×(Y1/(Y1+Y2)) from the longitudinal position Py on the lower side as the lower cutting line D1. The processor 42 confirms a position separated by a distance obtained by performing a calculation of Yset×(Y2/(Y1+Y2)) from the longitudinal position Py on the upper side as the upper cutting line U1. Then, a region surrounded by these four lines is cut out from the first image data IMa and used as second image data.

As described above, in the image processing apparatus 4, the first composition of the face F in the lateral direction is determined based on the orientation of the face F, the second composition of the face F in the longitudinal direction is determined based on the longitudinal position of the face F, and the second image data is generated based on the lateral cutting width and the longitudinal cutting width that are set based on the first composition and the second composition.

Accordingly, second image data of the composition considering the orientation of the face F in the lateral direction can be obtained, and second image data of the composition considering the longitudinal position of the face F in the longitudinal direction can be obtained. In addition, since the cutting width can be set individually in the longitudinal direction and the lateral direction, the proportion of the face F in the second image data and the imaging region captured as the second image data are not fixed, and a variety of second image data can be generated.

In particular, the processor 42 sets the lateral cutting width and the longitudinal cutting width using the probability distribution in addition to the first composition and the second composition. Therefore, even in a case in which the second image data is generated from each of many pieces of first image data including the same subject in the same composition, the lateral cutting width and the longitudinal cutting width are randomly set, and the second image data having various lateral cutting widths and various longitudinal cutting widths can be generated. Therefore, the variation of the second image data can be increased, and the satisfaction of people who view or purchase the second image data can be increased.

A modification example of the operation of the image processing apparatus 4 will be described below.

### First Modification Example

A plurality of probability distributions may be stored in the memory 43, and the processor 42 may select one of the plurality of probability distributions stored in the memory 43 for the probability distributions used in Step S7 and Step S8 of FIG. 3. Examples of a method of selecting one of the plurality of probability distributions include the following [Method A] to [Method D].

### [Method A]

The processor 42 selects a pre-designated probability distribution from a user.

According to this method, it is possible to generate the second image data reflecting the intention of a user.

### [Method B]

The processor 42 randomly selects one of the plurality of probability distributions, and stores a usage history of the probability distribution used when the second image data was generated in the past, in the memory 43. In a case in which the processor 42 determines that there is a probability distribution having a low usage frequency from this usage history, the processor 42 preferentially selects this probability distribution having a low usage frequency. In this way, the processor 42 selects one of a plurality of probability distributions based on the second image data generated in the past.

According to this method, the second image data can be generated by uniformly using a plurality of probability distributions, and the variation of the second image data can be increased.

### [Method C]

The processor 42 selects one of a plurality of probability distributions based on an attribute of the subject included in the first image data (for example, whether the subject is an adult or a child). For example, it is assumed that there is a request that an adult wants image data in which a face is largely reflected, whereas a child wants image data in which the entire body is reflected. In this case, in a case in which the first image data includes an adult as a subject, the processor 42 sets the cutting width using the probability distribution illustrated in FIG. 17. On the other hand, in a case in which the first image data includes a child as a subject, the processor 42 sets the cutting width using the probability distribution illustrated in FIG. 18.

The fact that a set value of the cutting width is close to the lower limit value means that the size of the subject in the second image data obtained by the trimming will be large. On the contrary, the fact that a set value of the cutting width is close to the upper limit value means that the size of the subject in the second image data obtained by the trimming will be small. Therefore, according to this method, in a case in which the subject is an adult, the second image data in a state in which the face is enlarged can be generated, and in a case in which the subject is a child, the second image data in a state in which a large number of portions other than the face of the child are reflected can be generated. In this way, it is possible to generate optimal second image data in accordance with the attribute of the subject.

### [Method D]

The processor 42 selects one of a plurality of probability distributions based on the attribute (whether the imaging apparatus 1 is for a telephoto or for a wide angle) of the imaging apparatus 1 that has captured the first image data. For example, it is assumed that the plurality of imaging apparatuses 1 include an imaging apparatus 1 equipped with a telephoto lens and an imaging apparatus 1 equipped with a wide angle lens. In a case in which the first image data captured by the imaging apparatus 1 equipped with the telephoto lens is acquired, the processor 42 sets the cutting width using the probability distribution illustrated in FIG. 17. In a case in which the first image data captured by the imaging apparatus 1 equipped with the wide angle lens is acquired, the processor 42 sets the cutting width using the probability distribution illustrated in FIG. 18.

Since the imaging apparatus 1 equipped with the telephoto lens is intended to capture an image of a subject so that the subject appears large, the second image data intended for the imaging apparatus 1 can be generated by using the probability distribution of FIG. 17 in which the cutting width close to the lower limit value is easily selected. Since the imaging apparatus 1 equipped with the wide angle lens is intended to capture an image of a subject so that the entire body of the subject appears, the second image data intended for the imaging apparatus 1 can be generated by using the probability distribution of FIG. 18 in which the cutting width close to the upper limit value is easily selected.

### Second Modification Example

The processor 42 stores a setting history of the lateral cutting width and the longitudinal cutting width set in the past in the memory 43. In a case in which the lateral cutting width and the longitudinal cutting width are set in Step S7 and Step S8 in FIG. 3, the processor 42 refers to the above-described setting history, and randomly selects and sets the lateral cutting width and the longitudinal cutting width from among probability variables in which a cumulative number of times selected in the probability distribution in the past is equal to or less than a threshold value in accordance with a probability distribution. In this way, the lateral cutting width and the longitudinal cutting width that are not selected for a long period of time are easily selected, and the variation of the second image data can be increased.

### Third Modification Example

In the above description, it has been assumed that there is no restriction on the aspect ratio of the second image data generated by trimming. In a case in which there is a restriction on the aspect ratio of the second image data, it is preferable to set the lateral cutting width and the longitudinal cutting width in consideration of the aspect ratio.

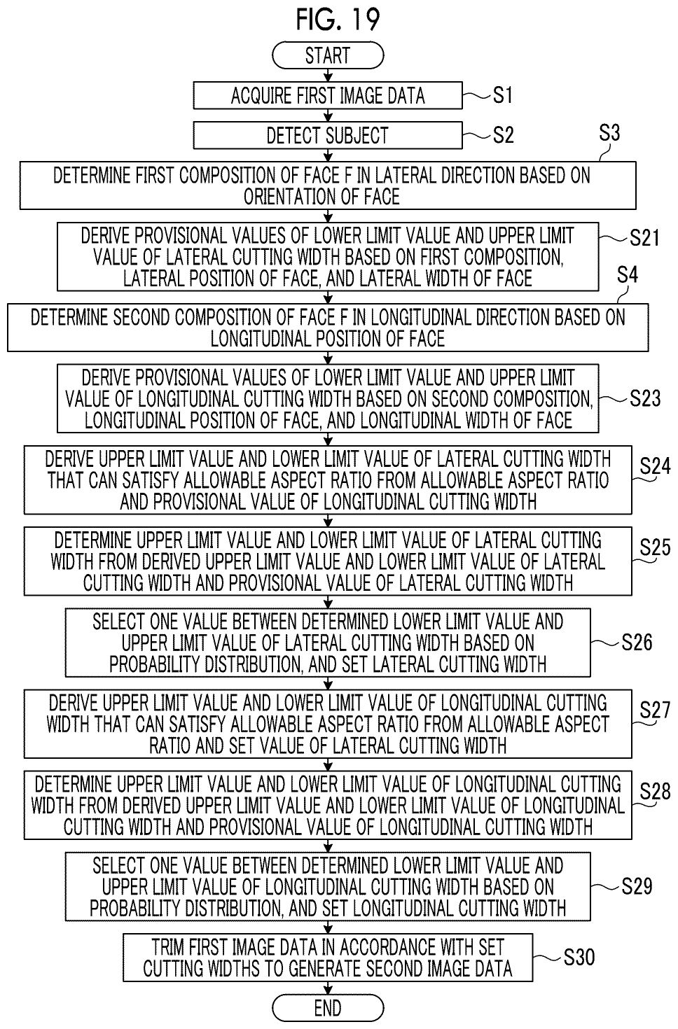

FIG. 19 is a flowchart for describing a modification example of the image editing process by the processor 42. Steps S1 to S4 in FIG. 19 are the same as Steps S1 to S4 in FIG. 3, and therefore the description thereof will be omitted. Here, a case in which the allowable aspect ratio of the second image data is height:width=1:2 will be described as an example.

After Step S3, the processor 42 derives provisional values of the lower limit value and the upper limit value of the lateral cutting width based on the first composition, the lateral position of the face F, and the lateral width of the face F (Step S21), and performs the process of Step S4. The provisional value derived in Step S21 is the same as the value determined in Step S5 of FIG. 3. In the following description, the upper limit value of the lateral cutting width derived in Step S21 is set to 1200, and the lower limit value thereof is set to 900.

After Step S4, the processor 42 derives provisional values of the lower limit value and the upper limit value of the longitudinal cutting width based on the second composition, the longitudinal position of the face F, and the longitudinal width of the face F (Step S23). The provisional value derived in Step S23 is the same as the value determined in Step S6 of FIG. 3. In the following description, the upper limit value of the longitudinal cutting width derived in Step S23 is set to 400, and the lower limit value thereof is set to 500.

After Step S23, the processor 42 derives an upper limit value and a lower limit value of the lateral cutting width that can satisfy the allowable aspect ratio from the allowable aspect ratio and the provisional value of the longitudinal cutting width (Step S24). The upper limit value of the lateral cutting width that can satisfy the allowable aspect ratio is derived as a value (=1000) that is twice the provisional value (=500) of the upper limit value of the longitudinal cutting width. The lower limit value of the lateral cutting width that can satisfy the allowable aspect ratio is derived as a value (=200) that is 1/2 times the provisional value (=400) of the lower limit value of the longitudinal cutting width.

After Step S24, the processor 42 determines the upper limit value and the lower limit value of the lateral cutting width from the upper limit value (=1000) and the lower limit value (=200) of the lateral cutting width derived in Step S24 and the provisional value of the lateral cutting width derived in Step S21 (Step S25). Specifically, the upper limit value (=1000) and the lower limit value (=900) of the lateral cutting width are determined by obtaining a condition (900 or more and 1000 or less) that satisfies both the condition of the provisional value (900 or more and 1200 or less) of the lateral cutting width and the condition of the value (200 or more and 1000 or less) of the lateral cutting width derived in Step S24.

After Step S25, the processor 42 selects one value between the lower limit value (=900) and the upper limit value (=1000) of the lateral cutting width determined in Step S25 based on the probability distribution described above, and sets the lateral cutting width (Step S26). In the following description, the lateral cutting width set in Step S26 is set to 950.

After Step S26, the processor 42 derives an upper limit value and a lower limit value of the longitudinal cutting width that can satisfy the allowable aspect ratio from the allowable aspect ratio and the set value (=950) of the lateral cutting width (Step S27). The upper limit value of the longitudinal cutting width that can satisfy the allowable aspect ratio is derived as a value (=1900) that is twice the set value (=950) of the lateral cutting width. The lower limit value of the longitudinal cutting width that can satisfy the allowable aspect ratio is derived as a value (=475) that is 1/2 times the set value (=950) of the lateral cutting width.

After Step S27, the processor 42 determines the upper limit value and the lower limit value of the longitudinal cutting width from the upper limit value (=1900) and the lower limit value (=475) of the longitudinal cutting width derived in Step S27 and the provisional value (=400, 500) of the longitudinal cutting width (Step S28). Specifically, the upper limit value (=500) and the lower limit value (=475) of the longitudinal cutting width are determined by obtaining a condition (475 or more and 500 or less) that satisfies both the condition of the provisional value (400 or more and 500 or less) of the longitudinal cutting width and the condition of the value (475 or more and 1900 or less) of the longitudinal cutting width derived in Step S27.

After Step S28, the processor 42 selects one value between the lower limit value (=475) and the upper limit value (=500) of the longitudinal cutting width determined in Step S28 based on the probability distribution described above, and sets the longitudinal cutting width (Step S29).

Finally, the processor 42 trims the first image data in accordance with the lateral cutting width set in Step S26 and the longitudinal cutting width set in Step S29 to generate second image data (Step S30).

As described above, by setting the cutting width based on the allowable aspect ratio of the second image data to be finally generated, it is possible to generate second image data with an aspect ratio desired by the user in various variations.

### Third Modification Example

The processor 42 may set the lateral cutting width and the longitudinal cutting width without using a probability distribution. For example, the processor 42 may set the lateral cutting width and the longitudinal cutting width to their respective lower limit values. By setting the cutting width to the lower limit value, it is possible to generate second image data in a state in which the face F included in the first image data is enlarged to the maximum extent possible. Alternatively, the processor 42 may generate the second image data by setting the cutting width to a value between the lower limit value and the upper limit value such that the size of the face F in the second image data is equal to or greater than the threshold value. In this way, it is possible to stabilize the size of the face F in the second image data in a large state.

### Fourth Modification Example

The processor 42 may determine information used to determine the first composition based on the attribute (whether the imaging apparatus 1 is for a telephoto or for a wide angle) of the imaging apparatus 1 that has captured the first image data. For example, the processor 42 refers to the attribute information included in the first image data in Step S3 in FIG. 3. Then, in a case in which the imaging apparatus 1 having the attribute information is an imaging apparatus set such that the proportion of the face in the imaging range is large (high zoom magnification, use of a telephoto optical system, or the like), the processor 42 determines the first composition of the face in the lateral direction using the lateral position of the face, the lateral width of the face, and the orientation of the face detected in Step S2 as the first information. On the other hand, in a case in which the imaging apparatus 1 having the attribute information is an imaging apparatus set such that a ratio of the face to an imaging range is small (such that the entire body of the subject is captured) (low zoom magnification, use of a wide angle optical system, or the like), the processor 42 determines the first composition of the face in the lateral direction using the lateral position of the subject, the lateral width of the subject, and the orientation of the face detected in Step S2 as the first information. Similarly, the processor 42 may determine information used to determine the second composition based on the attribute (whether the imaging apparatus 1 is for a telephoto or for a wide angle) of the imaging apparatus 1 that has captured the first image data.

In this way, it is possible to generate second image data in which the face is larger and second image data that includes the face and the body and in which the face is relatively smaller, in accordance with the purpose of the imaging apparatus 1 that has captured the first image data. Therefore, it is possible to generate second image data reflecting the intention of installing each imaging apparatus 1 in the system and to provide the user with highly valuable second image data.

### Fifth Modification Example

The processor 42 may determine the information used to determine the first composition based on content of the first image data (in other words, an imaging scene when the first image data was captured). For example, in Step S3 in FIG. 3, the processor 42 analyzes the first image data to determine the imaging scene when the first image data was captured. For example, as imaging scenes, a first scene in which a subject is playing a sport and a second scene in which the subject is stationary are assumed.

In a case in which the imaging scene is the second scene, the processor 42 determines the first composition of the face in the lateral direction using the lateral position of the face, the lateral width of the face, and the orientation of the face detected in Step S2 as the first information. On the other hand, in a case in which the imaging scene is the first scene, the processor 42 determines the first composition of the face in the lateral direction using the lateral position of the subject, the lateral width of the subject, and the orientation of the subject detected in Step S2 as the first information. Similarly, the processor 42 may determine the information used to determine the second composition based on the imaging scene of the first image data.

In this way, it is possible to generate second image data in which the face is larger and second image data that includes the face and the body and in which the face is relatively smaller, in accordance with the imaging scene when the first image data was captured. Therefore, it is possible to generate appropriate second image data in accordance with the imaging scene and to provide the user with highly valuable second image data.

### Sixth Modification Example

In the above description, the processor 42 generates the second image data by setting the cutting width based on the first image data and trimming the first image data in accordance with the set cutting width.

However, the processor 42 may generate the second image data by setting the cutting width based on the first image data captured at a first timing, and trimming the first image data (corresponding to the third image data) captured at a second timing after the first timing in accordance with the cutting width. The imaging apparatus 1 that captured the first image data captured at the first timing and the imaging apparatus 1 that captured the first image data captured at the second timing may be the same or different.

The method of the sixth modification example and the method D (method of selecting one of a plurality of probability distributions based on the attribute of the imaging apparatus 1 that captured the first image data) of the first modification example can also be combined. In this case, the processor 42 may set the cutting width based on the first image data (acquired in Step S1 of FIG. 3) captured at the first timing and the attribute of the imaging apparatus 1 that captures the first image data (that is, the image data to be acquired in the future as a target for trimming) captured at the second timing. Specifically, in Step S7 and Step S8 in FIG. 3, the processor 42 may select one of a plurality of probability distributions based on the attribute of the imaging apparatus 1 that captures the first image data (that is, the image data as a target for trimming) captured at the second timing.

### Seventh Modification Example

In the above description, the processor 42 generates the second image data by setting the cutting width based on the first image data and trimming the first image data in accordance with the set cutting width.

However, the second image data may be generated by causing the imaging apparatus 1 that has captured the first image data to perform imaging in the imaging range according to the cutting width set as described above. In this imaging, at least one of a zoom magnification, a position of the optical axis, or a crop range is controlled such that the position of the subject in the imaging range is a position based on the first composition and the second composition (in other words, has the same composition as the second image data generated by trimming).

In the seventh modification example, the imaging apparatus 1 is capable of, for example, changing a zoom magnification, changing a position of an optical axis (a position in a plane perpendicular to the optical axis), and performing crop imaging that limits a recording range of a signal from the imaging element.

After setting the cutting width based on the first image data, the processor 42 controls the zoom magnification, the optical axis position, or the crop range of the imaging apparatus 1 that has captured the first image data such that image data having the same composition as second image data generated by trimming the first image data with the set cutting width can be captured, and causes the imaging apparatus 1 to execute the imaging in the control state. By this imaging, it is possible to obtain second image data having the same composition as that obtained by trimming the first image data.

Note that the processor 42 may control a zoom magnification, an optical axis position, or a crop range of another imaging apparatus 1 (corresponding to the second imaging apparatus) different from the imaging apparatus 1 (corresponding to the first imaging apparatus) that has captured the first image data, and may cause the different imaging apparatus 1 to execute imaging to obtain the second image data in the control state.

The seventh modification example can be combined with the first modification example (the process of FIG. 19). In a case in which the seventh modification example and the first modification example are combined, it is preferable that the cutting width is determined based on the first image data and the probability distribution, and the set aspect ratio in the imaging apparatus 1 (the imaging apparatus 1 that has captured the first image data or another imaging apparatus 1 different from the imaging apparatus 1 that has captured the first image data) that is the imaging source of the second image data.

For example, in Step S24 in FIG. 19, the processor 42 derives an upper limit value and a lower limit value of the lateral cutting width that can satisfy the set aspect ratio from the provisional value of the set aspect ratio and the longitudinal cutting width of the imaging apparatus 1 that is the imaging source of the second image data.

Here, it is assumed that the set aspect ratio is height:width=2:3, the provisional value of the upper limit value of the longitudinal cutting width is 700, and the provisional value of the lower limit value of the longitudinal cutting width is 400. The upper limit value of the lateral cutting width that can satisfy the set aspect ratio is derived as a value (=1050) that is 3/2 times the provisional value (=700) of the upper limit value of the longitudinal cutting width. In addition, the lower limit value of the lateral cutting width that can satisfy the set aspect ratio is derived as a value (=600) that is 3/2 times the provisional value (=400) of the lower limit value of the longitudinal cutting width.

Therefore, in Step S25 of FIG. 19, under the condition (900 or more and 1050 or less) that satisfies both the condition of 600 or more and 1050 or less and the condition of 900 or more and 1200 or less, the lower limit value of the lateral cutting width is determined as 900 and the upper limit value of the longitudinal cutting width is determined as 1050.

Then, in next Step S26, the lateral cutting width is set in accordance with the probability distribution between the upper limit value and the lower limit value. In this example, since the set aspect ratio of the imaging apparatus 1 that is the imaging source of the second image data is 3:2, in a case in which the lateral cutting width is set, the longitudinal cutting width is set to 2/3 times the set value of the lateral cutting width in accordance with the set aspect ratio.

In a case in which the lateral cutting width is set, the processor 42 determines the zoom magnification of the imaging apparatus 1 that is the imaging source of the second image data based on the imaging size of the lateral width set in the imaging apparatus 1 that is the imaging source of the second image data set and the set lateral cutting width.

Specifically, the processor 42 determines the value obtained by dividing the imaging size of the lateral width by the set value of the lateral cutting width as the zoom magnification. The processor 42 can obtain second image data whose composition substantially matches the second image data in a case in which the second image data is generated by trimming according to the set value of the cutting width by causing the imaging apparatus 1 to execute the imaging in accordance with the zoom magnification.

In addition, in the seventh modification example, the cutting width may be determined based on the first image data and the probability distribution, and the zoom performance and the imaging condition (the set zoom magnification and the imaging size) in the imaging apparatus 1 that is the imaging source of the second image data. The detailed operations will be described below.

After performing the same processing as in Step S1 to Step S6 in FIG. 3, the processor 42 adjusts the upper limit value and the lower limit value of the lateral cutting width based on the zoom performance (the settable range of the zoom magnification) and the set value of the zoom magnification of the imaging apparatus 1 that is the imaging source of the second image data, and the imaging size of the lateral width set in the imaging apparatus 1. Here, it is assumed that the zoom performance is 1 times or more and 4 times or less, the set value of the zoom magnification is 1.6 times, and the set value of the imaging size of the lateral width is 1600 pixels.

Specifically, the processor 42 derives the lower limit value (=1000) of the lateral cutting width by a calculation of (1600/1.6)×1 and derives the upper limit value (=4000) of the lateral cutting width by a calculation of (1600/1.6)×4.

Next, the processor 42 adjusts the lower limit value of the lateral cutting width to 1000 and adjusts the upper limit value of the longitudinal cutting width to 1200 from the condition (1000 or more and 1200 or less) that satisfies both the derived condition of 1000 or more and 4000 or less and the condition of 900 or more and 1200 or less determined in Step S5 of FIG. 3. Then, the processor 42 sets the lateral cutting width between the upper limit value and the lower limit value after the adjustment in accordance with the probability distribution.

In a case in which the lateral cutting width is set, the processor 42 determines the zoom magnification of the imaging apparatus 1 that is the imaging source of the second image data based on the imaging size of the lateral width set in the imaging apparatus 1 that is the imaging source of the second image data set and the set lateral cutting width.

Specifically, the processor 42 determines the value obtained by dividing the imaging size of the lateral width by the set value of the lateral cutting width as the zoom magnification. The processor 42 performs the process of Step S8 in FIG. 3 in parallel to set the longitudinal cutting width. Moreover, the processor 42 determines a ratio of the set value of the longitudinal cutting width to the set value of the lateral cutting width (referred to as an aspect ratio).

Next, the processor 42 causes the imaging apparatus 1 to execute imaging in accordance with the determined zoom magnification, and sets a crop range such that the longitudinal width of the image data to be captured is a value obtained by multiplying the lateral width by the aspect ratio. Accordingly, the image data obtained by imaging of the imaging apparatus 1 can have a composition that substantially matches the second image data in a case in which the second image data is generated by trimming according to the cutting width set by the processor 42.

### Eighth Modification Example

The processor 42 acquires the orientation of the subject included in the first image data by performing the subject detection process on the first image data. However, in a case in which an image of the same subject is captured by another imaging apparatus 1 different from the imaging apparatus 1 that has captured the first image data, the orientation of the subject may be acquired based on the result of the subject detection process on the image data acquired from the other imaging apparatus 1. Alternatively, assuming that the subject is wearing a device that transmits beacon information, in a case in which the first image data is captured, the first image data is stored in association with the beacon information received by the imaging apparatus 1 when the first image data is captured. Moreover, the processor 42 may acquire information regarding the orientation of the subject included in the first image data based on the beacon information corresponding to the acquired first image data.

As described so far, at least the following matters are described in the present specification.

(1)

A processing apparatus comprising:
a processor; and
a memory,
in which the processor is configured to:
   acquire first image data including a subject;
   determine a first composition of the subject in a first direction based on first information regarding a state of the subject;
   determine a second composition of the subject in a second direction different from the first direction based on second information different from the first information regarding the state of the subject; and
   generate second image data based on the first composition and the second composition.
      (2)

The processing apparatus according to (1),
in which the first information includes information regarding an orientation of the subject in the first image data, and
the second information includes information regarding a position of the subject in the first image data.
   (3)

The processing apparatus according to (2),
in which the second information does not include the information regarding the orientation of the subject in the first image data.
   (4)

The processing apparatus according to any one of (1) to (3),
in which a ratio of a width of an imaging region included in the second image data in the first direction to a width of an imaging region included in the first image data in the first direction is set as a first ratio, and
the processor is configured to set the first ratio based on the first information and the first composition.
   (5)

The processing apparatus according to (4),
in which the processor is configured to further set the first ratio based on a margin width set adjacent to the subject in the first direction.
   (6)

The processing apparatus according to (4) or (5),
in which the processor is configured to derive a lower limit value of the first ratio that is settable based on the first composition, the first information, and a margin width set adjacent to the subject in the first direction.
   (7)

The processing apparatus according to any one of (4) to (6),
in which the processor is configured to further set the first ratio based on a probability distribution of the first ratio.
   (8)

The processing apparatus according to (7),
in which the memory stores a plurality of the probability distributions, and
the processor is configured to set the first ratio based on any one of the plurality of probability distributions stored in the memory.
   (9)

The processing apparatus according to (8),
in which the processor is configured to select one of the plurality of probability distributions based on image data generated in the past.
   (10)

The processing apparatus according to (8),
in which the processor is configured to select one of the plurality of probability distributions based on an attribute of the subject.
   (11)

The processing apparatus according to (8),
in which the processor is configured to:
   generate the second image data based on the first image data or third image data different from the first image data; and
   select one of the plurality of probability distributions based on an attribute of an imaging apparatus that captures the first image data or the third image data.
      (12)

The processing apparatus according to any one of (4) to (11),
in which the processor is configured to further set the first ratio based on the first ratio set in the past.
   (13)

The processing apparatus according to any one of (4) to (11),
in which the processor is configured to further set the first ratio based on an allowable aspect ratio of the second image data.
   (14)

The processing apparatus according to any one of (4) to (11),
in which the processor is configured to:
   generate the second image data by causing a first imaging apparatus that has captured the first image data or a second imaging apparatus different from the first imaging apparatus to execute imaging; and
   further set the first ratio based on a set aspect ratio of the first imaging apparatus or the second imaging apparatus.
      (15)

The processing apparatus according to any one of (4) to (11),
in which the processor is configured to:
   generate the second image data by causing a first imaging apparatus that has captured the first image data or a second imaging apparatus different from the first imaging apparatus to execute imaging; and
   further set the first ratio based on an imaging condition of the first imaging apparatus or the second imaging apparatus.
      (16)

The processing apparatus according to any one of (4) to (6),
in which the processor is configured to generate the second image data by setting the first ratio to a lower limit value among settable values.
   (17)

The processing apparatus according to any one of (4) to (6),
in which the processor is configured to generate the second image data by setting the first ratio to a value at which a size of the subject in the second image data is equal to or greater than a threshold value.
   (18)

The processing apparatus according to any one of (1) to (17),
in which the processor is configured to:
   acquire the first image data from a plurality of imaging apparatuses; and
   determine the first information and the second information used for determining a composition based on an attribute of an imaging apparatus that has captured the first image data.
      (19)

The processing apparatus according to any one of (1) to (18),
in which the processor is configured to:
   acquire the first image data from a plurality of imaging apparatuses; and
   determine the first information and the second information used for determining a composition based on content of the first image data.
      (20)

The processing apparatus according to any one of (1) to (19),
in which the processor is configured to generate the second image data by trimming the first image data based on the first composition and the second composition.
   (21)

A processing method comprising:
acquiring first image data including a subject;
determining a first composition of the subject in a first direction based on first information regarding a state of the subject;
determining a second composition of the subject in a second direction different from the first direction based on second information different from the first information regarding the state of the subject; and
generating second image data based on the first composition and the second composition.
   (22)

A non-transitory computer-readable storage medium storing a processing program causing a processor to execute a process, the process including:
acquiring first image data including a subject;
determining a first composition of the subject in a first direction based on first information regarding a state of the subject;
determining a second composition of the subject in a second direction different from the first direction based on second information different from the first information regarding the state of the subject; and
generating second image data based on the first composition and the second composition.
   (23)

A processing apparatus comprising:
a processor; and
a memory,
in which the processor is configured to:
   acquire first image data including a subject;
   determine a first composition of the subject in a first direction based on first information regarding a state of the subject in the first image data;
   set a first ratio, which is a ratio of a width of second image data in the first direction to a width of the first image data in the first direction, based on the first information, the first composition, and a probability distribution; and generate the second image data based on the first ratio.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-030052) filed on Feb. 28, 2022, the content of which is incorporated in the present application by reference.

### EXPLANATION OF REFERENCES

1a, 1b, 1c, 1: imaging apparatus
R1: right cutting line
L1: left cutting line
U1: upper cutting line
D1: lower cutting line
X1, X2: distance
Y1, Y2: distance
2: network
3: image storage server
4: image processing apparatus
41: communication interface
42: processor
43: memory
100: image management system

What is claimed is:

1. A processing apparatus comprising:
a processor; and
a memory,
wherein the processor is configured to:
acquire first image data including a subject;
determine a first composition of the subject in a first direction based on first information regarding a state of the subject;
determine a second composition of the subject in a second direction different from the first direction based on second information different from the first information regarding the state of the subject; and
generate second image data based on the first composition and the second composition.

2. The processing apparatus according to claim 1,
wherein the first information includes information regarding an orientation of the subject in the first image data, and
the second information includes information regarding a position of the subject in the first image data.

3. The processing apparatus according to claim 2,
wherein the second information does not include the information regarding the orientation of the subject in the first image data.

4. The processing apparatus according to claim 1,
wherein a ratio of a width of an imaging region included in the second image data in the first direction to a width of an imaging region included in the first image data in the first direction is set as a first ratio, and
the processor is configured to set the first ratio based on the first information and the first composition.

5. The processing apparatus according to claim 4,
wherein the processor is configured to set the first ratio further based on a margin width set adjacent to the subject in the first direction.

6. The processing apparatus according to claim 4,
wherein the processor is configured to derive a lower limit value of the first ratio that is settable based on the first composition, the first information, and a margin width set adjacent to the subject in the first direction.

7. The processing apparatus according to claim 4,
wherein the processor is configured to set the first ratio further based on a probability distribution of the first ratio.

8. The processing apparatus according to claim 7,
wherein the memory stores a plurality of the probability distributions, and
the processor is configured to set the first ratio based on any one of the plurality of probability distributions stored in the memory.

9. The processing apparatus according to claim 8,
wherein the processor is configured to select one of the plurality of probability distributions based on image data generated in the past.

10. The processing apparatus according to claim 8,
wherein the processor is configured to select one of the plurality of probability distributions based on an attribute of the subject.

11. The processing apparatus according to claim 8,
wherein the processor is configured to:
generate the second image data based on the first image data or third image data different from the first image data; and
select one of the plurality of probability distributions based on an attribute of an imaging apparatus that captures the first image data or the third image data.

12. The processing apparatus according to claim 4,
wherein the processor is configured to set the first ratio further based on the first ratio set in the past.

13. The processing apparatus according to claim 4,
wherein the processor is configured to set the first ratio further based on an allowable aspect ratio of the second image data.

14. The processing apparatus according to claim 4,
wherein the processor is configured to:
generate the second image data by causing a first imaging apparatus that has captured the first image data or a second imaging apparatus different from the first imaging apparatus to execute imaging; and
set the first ratio further based on a set aspect ratio of the first imaging apparatus or the second imaging apparatus.

15. The processing apparatus according to claim 4,
wherein the processor is configured to:
generate the second image data by causing a first imaging apparatus that has captured the first image data or a second imaging apparatus different from the first imaging apparatus to execute imaging; and
set the first ratio further based on an imaging condition of the first imaging apparatus or the second imaging apparatus.

16. The processing apparatus according to claim 4,
wherein the processor is configured to generate the second image data by setting the first ratio to a lower limit value among settable values.

17. The processing apparatus according to claim 4,
wherein the processor is configured to generate the second image data by setting the first ratio to a value at which a size of the subject in the second image data is equal to or greater than a threshold value.

18. The processing apparatus according to claim 1,
wherein the processor is configured to:
acquire the first image data from a plurality of imaging apparatuses; and
determine the first information and the second information used for determining a composition based on an attribute of an imaging apparatus that has captured the first image data.

19. The processing apparatus according to claim 1,
wherein the processor is configured to:
acquire the first image data from a plurality of imaging apparatuses; and
determine the first information and the second information used for determining a composition based on content of the first image data.

20. The processing apparatus according to claim 1,
wherein the processor is configured to generate the second image data by trimming the first image data based on the first composition and the second composition.

21. A processing method comprising:
acquiring first image data including a subject;
determining a first composition of the subject in a first direction based on first information regarding a state of the subject;
determining a second composition of the subject in a second direction different from the first direction based on second information different from the first information regarding the state of the subject; and
generating second image data based on the first composition and the second composition.

22. A non-transitory computer-readable storage medium storing a processing program causing a processor to execute a process, the process comprising:
acquiring first image data including a subject;
determining a first composition of the subject in a first direction based on first information regarding a state of the subject;
determining a second composition of the subject in a second direction different from the first direction based on second information different from the first information regarding the state of the subject; and
generating second image data based on the first composition and the second composition.

23. A processing apparatus comprising:
a processor; and
a memory,
wherein the processor is configured to:
acquire first image data including a subject;
determine a first composition of the subject in a first direction based on first information regarding a state of the subject in the first image data;
set a first ratio, which is a ratio of a width of second image data in the first direction to a width of the first image data in the first direction, based on the first information, the first composition, and a probability distribution; and
generate the second image data based on the first ratio.
